(19) United States
(12) Patent Application Publication
(10) Pub. No.: US 2003/0196375 A1
(43) Pub. Date: Oct. 23, 2003

(54) Method of producing deep-rooted trees for phytoremediation applications

(76) Inventor: Ari M. Ferro, North Logan, UT (US)

Correspondence Address: ALAN J. HOWARTH, P.O. BOX 1909, SANDY, UT, 84091-1909, US

(21) Appl. No.: 10/421,070

(22) Filed: Apr. 22, 2003

Related U.S. Application Data
(60) Provisional application No. 60/375,198, filed on Apr. 23, 2002.

(51) Int. Cl. A01B 79/02

(52) U.S. Cl. 47/58.1 SC

(57) ABSTRACT

A method for producing deep-rooted trees for phytoremediation applications is shown. The method involves creating a hole of appropriate diameter and depth using direct push technology, installing a subsurface drip irrigation line down the hole, backfilling the hole, and planting a tree or cutting next to or inside the hole. The subsurface irrigation line is connected to a water supply line, to which an in-line aerator (oxygenator) and a nutrient injector apparatus (proportioner) may also be connected. A specific mixture of nutrients, root stimulant, microbes and/or surfactants may be added to the irrigation water via the proportioner with the objective of producing a subsurface environment in which roots can proliferate and the aerobic biodegradation of organic chemical contaminants is enhanced. As the trees develop, irrigation rates are regulated to encourage the drying of the upper soil layers and subsequent rooting in deeper layers of the soil. Using the method, trees of any species can be produced with deep roots even in contaminated soil.

### CROSS-REFERENCE TO RELATED APPLICATIONS

This application claims the benefit of U.S. Provisional Application No. 60/375,198, filed Apr. 23, 2002, which is hereby incorporated by reference.

### STATEMENT REGARDING FEDERALLY SPONSORED RESEARCH OR DEVELOPMENT

Not applicable.

### BACKGROUND OF THE INVENTION

This invention relates to phytoremediation. More particularly, this invention relates to methods for producing deep-rooted trees for phytoremediation applications,.

Phytoremediation is the use of plants to clean up or contain contaminants in soil, wastewater streams, or groundwater. The technology is used for both organic chemical contaminants and inorganics, including heavy metals, and has been used successfully as an alternative to conventional soil and groundwater remediation systems. Phytoremediation systems are generally classified as either groundwater phytoremediation systems or surface soil phytoremediation systems.

Groundwater phytoremediation systems are designed to control or contain contaminated groundwater using deep-rooted, water-loving trees. A stand of deep-rooted trees can act as a biological “pump,” removing a considerable amount of water from the saturated zone. During the growing season, when the trees are actively transpiring, a zone of capture is created, in which all of the groundwater within a specific thickness of the saturated zone is used by the trees (Ferro et al., Maintaining hydraulic control using deep rooted tree systems, in 78 Advances in Biochemical Engineering Biotechnology 12-156 (T. Scheper & D. T. Tsao eds, Springer-Verlag 2003)). In order to achieve hydraulic control in a specific area, the trees must be able to transpire a sufficient amount of water from the saturated zone. Thus, the extent of the tree's root system is crucial to the success of the phytoremediation system. Since most trees are naturally shallow-rooted, special cultural practices are sometimes necessary to obtain trees with roots that are deep enough to tap into the water table. These cultural practices include, for example, drilling deep boreholes, backfilling the holes with clean rooting media, and in some cases providing a passive supply of air to the subsurface to allow root respiration (Ferro et al., Groundwater capture using hybrid poplar trees: Evaluation of a system in Ogden, Utah, 3 Int'l J. Phytoremediation 87-104 (2001)). However, producing deep-rooted trees in this way can be expensive and labor intensive.

As plants take up contaminated water via transpiration, dissolved organic contaminants within the zone of capture may become sorbed to root tissue or soil particles, biodegraded in the root zone, or taken up by the plants. These processes can also act together to remove or stabilize contaminants in planted vadose zone soils, as described below.

Rhizosphere soil (the soil associated with plant roots) supports 10 to 100 times more microorganisms per gram than unplanted soil. This proliferation is largely due to a supply of carbon-containing compounds exuded by plant roots. Many of these bacteria and fungi can degrade organic contaminants. Plant root exudates can also stimulate co-metabolic transformations; certain organic contaminants cannot be used as a growth substrate by soil microbes, but in the presence of structurally related root exudates (co-metabolites), biodegradation is enhanced. Plants may also stimulate aerobic biodegradation by removing water via transpiration and subsequently increasing soil oxygen availability.

Some organic contaminants may be taken up into plants by a passive process related to the ability of the chemical to move through cell membranes. Once taken up, certain organic compounds can be metabolized by plant enzymes into less toxic forms. Certain volatile organic compounds can exit the tree via the transpiration gas, a process called phytovolatilization.

Many types of organic chemical contaminants are lipophilic and become sorbed to the hydrophobic surfaces on organic matter. These compounds may bind to living or dead plant root tissue and become immobilized. Immobilization may be a result of contaminants binding to humus (humification), plant cell wall components, or soil particles. Bound residues cannot be removed from soil by conventional extraction techniques and therefore are thought to be less toxic, less bioavailable, and less mobile than free species.

Some of the major limitations to surface soil and groundwater phytoremediation systems are phytotoxicity and depth to groundwater. For both soil and groundwater phytoremediation, high levels of contaminants may result in stunting of plant growth or death of the plants. For groundwater phytoremediation systems, depth to groundwater is frequently a limiting factor.

Various patents and publications describe methods for producing deep-rooted plants. In many of the cases, the deep-rooted plants are used for phytoremediation applications. For example, U.S. Pat. No. 5,829,191 to Gatliff presents a method by which trees can be grown to encourage deep root growth and can be easily transplanted at contaminated sites. The method involves growing trees in a narrow hole backfilled with optimal rooting medium. A cap can be placed at the bottom of the hole to prevent roots from exiting the hole. U.S. Pat. No. 5,829,192 to Gatliff also presents a method for improving rooting depth of trees planted at sites with contaminated soil, in which a backfilled hole is lined with a casing to prevent roots from exploring contaminated soil. The method is used primarily for sites at which groundwater phytoremediation is the primary objective. U.S. Pat. No. 6,360,480 to Christensen also presents a method for facilitating deep phytoremediation. This method involves planting a tree very deeply and coating the trunk with substances that will encourage root growth or protecting the trunk after it is planted to prevent root growth or rotting.

One of the most common methods for encouraging deep root growth involves planting poles (long hardwood cuttings; described in J. A. Briggs & B. Munda, Collection, evaluation, selection and production of cottonwood poles for riparian area improvement: Final report to the US Fish & Wildlife Service (1992); G. Fenchel et al.; Plant development for riparian areas in the Southwest United States, Natural Resources Conservation Service, Los Lunas Plant Materials Center, Los Lunas, N. Mex.; USDA-Soil Conservation Service, How to plant willows and cottonwoods for riparian rehabilitation, TN Plant Materials No. 23 (1993); International Poplar Commission, Poplars and willows in wood production and land use (FAO Rome 1979)). The poles may be eight to nine feet in length. For many phytoremediation applications, poplar or willow poles are deeply planted in boreholes backfilled with a rooting medium (Ferro et al., 2001; Ferro et al., 2003). Augers are typically used to create the holes for planting, and slotted PVC pipes (“breather tubes”) are installed in the boreholes for the passive supply of air to the subsurface for root respiration. Some limitations of the pole planting method are that the poles must be planted in early spring, and the plant varieties are limited to poplar and willow tree clones that are commercially available as long hardwood cuttings.

In view of the foregoing, it will be appreciated that methods for producing deep-rooted trees for phytoremediation applications would be a significant advancement in the art.

### BRIEF SUMMARY OF THE INVENTION

The present invention provides a method for producing deep-rooted trees for phytoremediation applications that is less expensive and more efficient than current methods. Most of the other methods of planting involve drilling large diameter boreholes and backfilling with rooting medium. Drilling rigs are expensive to hire, and it is labor intensive and time consuming to drill and backfill boreholes. An additional cost is the disposal of contaminated drilling waste. The present invention utilizes direct push technology, so no drilling waste is generated, and the system takes much less time to install (i.e., using a single work crew, many more trees per day can be installed than is possible with a drilling rig). The trees can then be planted using conventional methods or alternatively, poplar and willow poles can be planted in the same hole with the subsurface irrigation line. Because conventional planting methods can be employed, any species of tree can be used, and the trees can be planted throughout the growing season using conventional stock (e.g., containerized, balled and burlapped, bare root).

It is also an advantage of the present invention to provide a method by which roots can develop very deeply and extensively in the soil without removing or replacing the soil where the tree is planted. Some of the prior art limits root growth to a certain volume of soil. For instance, the invention proposed by U.S. Pat. No. 5,829,192 limits root growth to the area inside a narrow casing. Although the roots are able take up water and proliferate in the casing, roots are not able to grow laterally, and thus the tree is subject to blowing over during wind storms.

It is another advantage of the present invention to provide a method by which biodegradation of contaminants in the root zone may be enhanced prior to or at the same time roots are developing in that area. Most of the other methods rely on removing contaminated soil and replacing it with a clean rooting medium. The present invention allows trees to become established at the contaminated site, but instead of replacing the soil with clean rooting medium, the method encourages biodegradation and removal of contaminants in the root-zone of the developing tree. This is achieved by introducing microbes, altering the rooting environment to support vigorous root growth and large microbial communities, and making contaminants more bioavailable to degrading microbes by using surfactants.

The advantages of the present invention are achieved by installing vertical subsurface drip irrigation lines using direct push technology (e.g. using a Geoprobe or AMS PowerProbe system), backfilling the small diameter holes, and planting trees adjacent to or in the holes containing the subsurface irrigation lines. The trees are irrigated with clean water via the subsurface irrigation lines in a way that will encourage deep rooting. The irrigation lines may also be connected to an in-line aerator (oxygenator) and to a nutrient injector (a system that injects a concentrated solution, at a specified rate, into the water stream), which delivers a solution to the soil that encourages root growth and aerobic biodegradation of contaminants in the soil.

The present invention can be used to promote deep-rooted trees for groundwater phytoremediation applications (where no soil contaminants are present), to encourage roots to grow deeply and extensively through contaminated soils for phytoremediation of the deep vadose zone, or to create a clean column of soil at a site with soil contamination through which roots can grow for groundwater phytoremediation applications. For applications of the present invention for groundwater phytoremediation, the subirrigation of the trees can be discontinued once the tree roots extend to the saturated zone and the trees start using groundwater as a source of moisture.

### BRIEF DESCRIPTION OF THE SEVERAL VIEWS OF THE DRAWINGS

FIG. 1 is an overview of the present invention showing the main irrigation line and in-line aerator (oxygenator) and proportioner (nutrient injector) connected to the vertical subsurface drip irrigation line, which extends through a backfilled hole created using direct push technology (not drawn to scale).

FIG. 2 shows the tooling used to install a vertical subsurface drip line with a Geoprobe system using a hollow rod and expendable tip.

FIG. 3 shows the dual tube tooling needed to the install the vertical subsurface drip line with an AMS PowerProbe or Geoprobe machine.

FIGS. 4A and B illustrates the rooting patterns that are expected to occur with trees that are A) established using the present invention and B) planted and irrigated using conventional methods.

FIGS. 5A and B show the theoretical movement of water from a vertical subsurface drip irrigation line (applied for 0.5, 1, and 2 hours) into a sandy loam soil at a drip rate of 0.9 gallons per hour per emitter. A) Plan view. B) Side view. The figure shows how zones of soil moisture would migrate via unsaturated flow from a point source (drip emitter). The extent of the wetted front is dependent upon the irrigation time and the soil texture. The assumption is made that at the beginning of the irrigation cycle, the soil has minimal plant-available water.

FIG. 6 illustrates the method of backfilling from the bottom to the top of the hole using a grouting machine.

FIG. 7 shows the readings from soil moisture probes (in kilopascals, kPa) installed in backfilled boreholes with and without trees and subirrigated with drip lines installed vertically in the boreholes. Soil moisture sensors were installed at 6, 8, and 10 ft below ground surface (bgs). The three sets of data that are presented in the figure are for pairs of planted and unplanted boreholes within the same row of trees, and are from an installation of deep-rooted trees in Billings, Mont. during the first growing season.

### DETAILED DESCRIPTION

Before the present methods for producing deep-rooted trees for phytoremediation applications are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

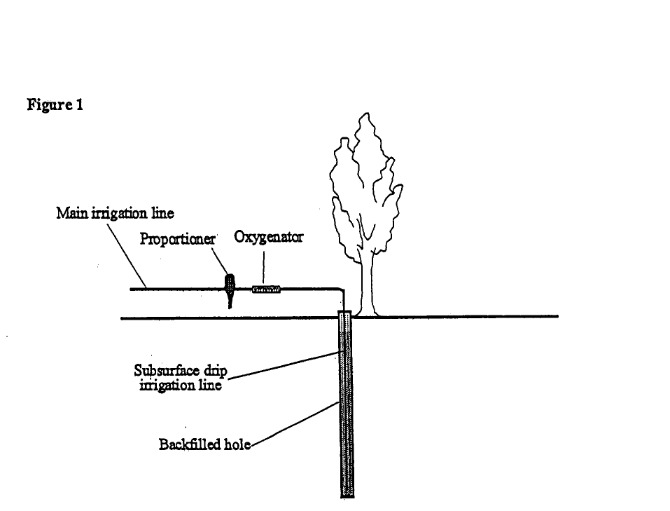

FIG. 1 shows an overview of the present invention. A hole is created with a direct push system, an irrigation line is installed vertically in the hole, and backfill is added from the bottom to the top of the hole. A tree is planted next to or in the hole. Water or a solution that stimulates root growth and/or aerobic biodegradation of contaminants may be added via the irrigation line throughout the growing season at a rate that will encourage deep root growth. Rooting depth may be monitored using soil moisture probes, positioned at different depths in the soil profile.

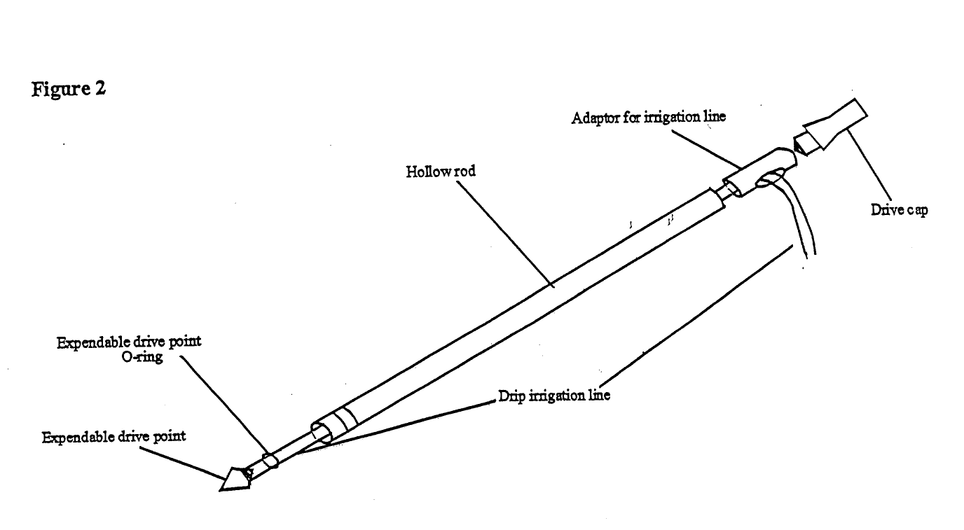

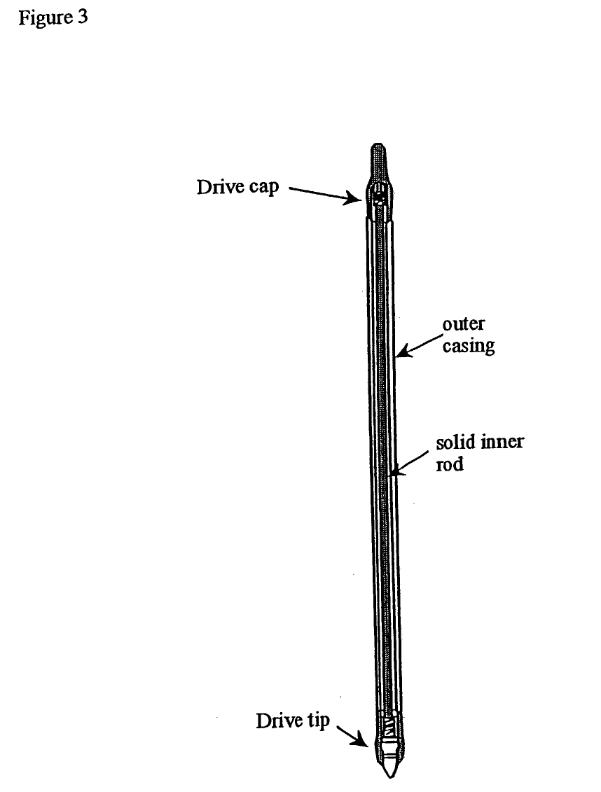

Creating the Hole. A hole is created using a Geoprobe system, AMS PowerProbe, or a similar unit, as illustrated in FIGS. 2 and 3. For the Geoprobe system, the hole can be created with a single hollow rod or a dual tube system (described below). FIG. 2 shows the first method: a hole is made using a hollow steel rod (1 in. to 2⅛, in. OD). The irrigation line is positioned inside the hollow rod and is attached to an expendable steel drive tip. The Geoprobe machine pushes the rod to the desired depth using a combination of percussive and static force. The machine then pulls the rod from the ground, leaving the steel tip and irrigation line anchored at the desired depth.

An AMS PowerProbe or Geoprobe with dual tube tooling may also be used. The dual tube tooling is shown in FIG. 3. The dual tube system is comprised of a solid steel rod (1⅛ in. to 1¼ in. OD) and a hollow steel outer casing (1¾ in. to 2¾ in. OD). The outer casing fits around the outside of the steel rod, and both components are driven into the ground together. Once the rod and casing reach the desired depth, the steel rod is removed, leaving the hollow outer casing in the ground. The irrigation line is inserted into the casing, and backfill is added to the bottom of the hole as the casing is pulled out of the ground. The backfill material holds the irrigation line in place as the casing is removed. In certain cases where soil conditions are favorable (the holes stay open and do not cave in), both components of the dual tube system can be removed from the ground and the irrigation lines can be inserted directly into the hole and the hole backfilled.

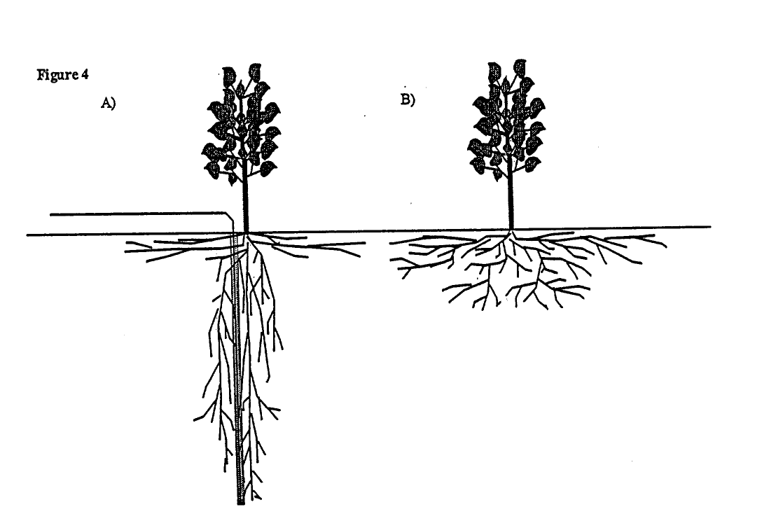

Installing the irrigation line. One or more subsurface drip irrigation lines (e.g. GeoFlow Wastline®) are installed vertically in the hole created by the Geoprobe or AMS PowerProbe machine, as described above. The drip line(s) extend from a certain depth in the hole to above ground level. (In the case of the dual tube systems, the drip line may be secured to a slender wood pole in order to straighten the line and facilitate its insertion into the casing). Subsurface drip irrigation lines must be small enough to fit in the hole and large enough to deliver an adequate amount of water to wet the surrounding soil and give the trees enough water, with emitters regularly spaced along the length of each line (e.g. 16 mm diameter line, with 0.5 gallon per hour emitters spaced every one foot). The drip lines may be impregnated with chemicals that inhibit root penetration into emitters and prevent bacteria and algae from building up inside the lines. For some applications, a blank line (no emitters) will be connected to the top several feet of each line. This will encourage deeper rooting, as water will be only available deeper via the drippers in the soil profile. In certain cases, two drip lines can be installed in the hole. For example, one line would have drip emitters in the top portion of the hole that are used during the initial stages of root growth. The second line would have emitters only in the deeper portion of the hole and would be used after the roots had attained that depth. The multiple drip lines would make the addition of substances to the irrigation water (e.g. surfactants) more economical. FIG. 4 shows A) the expected rooting pattern of a tree produced using the method of the present invention, planted with the vertically oriented irrigation line and B) the typical surficial rooting pattern of a tree that is planted and irrigated using conventional methods.

Planting the Tree. A single tree is planted next to or in the hole that contains the subsurface drip irrigation line(s). The tree may be planted using any of the following methods:

Conventional planting. Bareroot stock, containerized trees, or balled and burlapped trees may be used in this method. The tree is planted in a hole dug adjacent to or directly above the subsurface drip line. For this method, the subsurface irrigation line may contain emitters through the whole length of the line, or a blank line may be used on the top 1 to 2 ft. This method of planting can be used for any species of tree anytime within the growing season.

Pole planting. Some tree species, such as willows and poplars, may be planted as poles (long unrooted hardwood cuttings). This planting method is limited to spring or early summer. The cuttings can be 8 to 9 ft long and can be planted in backfilled boreholes adjacent to or directly above the subsurface irrigation line or in the same hole with the subsurface irrigation line. If a pole is planted in a borehole above the irrigation line, the borehole must be drilled before the irrigation line is installed. The hole for the subsurface irrigation line and the borehole are then backfilled, and the pole is planted into the backfill so up to the top 1 ft of the pole is above ground surface. Poles may also be planted in the same hole with the subsurface irrigation line as the hole is being backfilled (in which case the irrigation line would have emitters only deeper than 7 ft bgs).

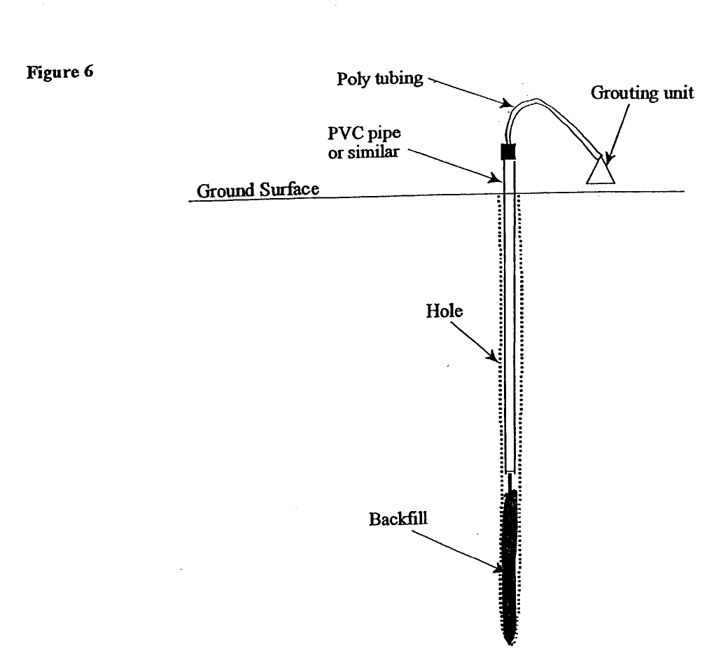

Backfilling. The hole containing the subsurface irrigation line is backfilled with a mixture of sand and compost, a mixture of sand and peat, a hydrophilic gel, or other substance that will allow water to move out into the soil. The backfill can be applied using a grouting machine or similar unit with appropriate tooling, which would allow the hole to be backfilled from the bottom to the top, as shown in FIG. 6.

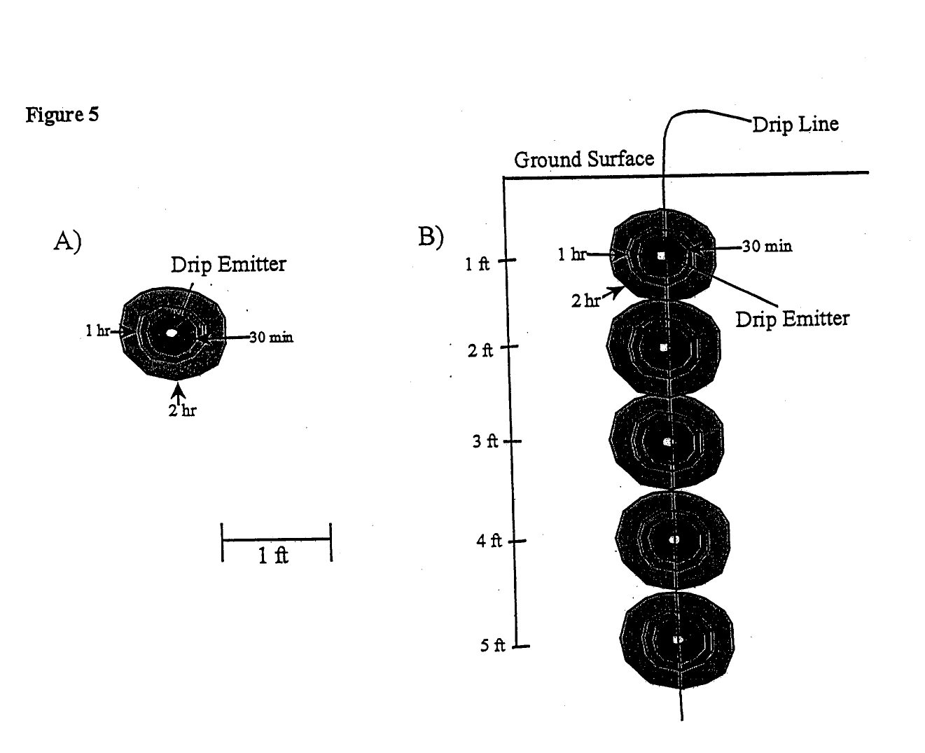

Irrigating. The irrigation system is designed to encourage rooting deep in the soil profile. Water is applied at set intervals, which are gradually decreased as roots grow downwards. The amount of water given at each irrigation event is determined by estimating the rate of water use by the tree. As the moisture content decreases in the upper portions of the soil profile, the roots are forced to grow more deeply in order to obtain water. FIG. 5 shows the movement of water via unsaturated flow through a sandy loam soil over a given amount of time.

Roots must respire, and oxygen is frequently a limiting factor for the development of very deep roots. In certain cases, therefore, the water may be passed through an in-line aerator or oxygenator to increase the concentration of dissolved oxygen, prior to delivery to the subirrigation system. Solutions may also be added to the irrigation water via a proportioner (nutrient injector) or similar device to encourage root growth and/or biodegradation of contaminants. For sites with contaminated soil, one advantage of the present invention is to form a column of clean soil through which deep roots can grow. Nutrients (macro and micro) can be added to encourage root proliferation and healthy plant growth as well as to enhance organic contaminant biodegradation. Such nutrients include N, P, K, S, Mg, Fe, Mn, Zn, Cu and Mo. Root stimulants may also be added to the solution to encourage root growth. Such root stimulants include appropriate concentrations of auxins (e.g. indoleacetic acid, indole butyric acid). For sites where soil remediation is desired surfactant solutions can be added, via the proportioner, to the subirrigation solution to increase the bioavailability of certain contaminants to soil microorganisms. Such surfactants include appropriate concentrations of glycolipids, lipopeptides, lipopolysaccharides, phospholipids, fatty acids and neutral lipids and can be within any class of surfactants, including anionic, cationic, nonionic, amphoteric and biosurfactants.

In some instances suspensions of microorganisms, may be introduced via the irrigation system to stimulate biodegradation. The microorganisms include bacteria (including those that are rhizosphere-competent) and fungi that have the enzymatic capability of degrading selected organic chemical contaminants, or that can benefit the plant. Such microbes include bacteria in the genera Achrobacteria, Acinetobacteria, Actinomyces, Aeromonas, Agrobacterium, Alcaligenes, Arthrobacter, Bacillus, Beijerinckia, Citrobacter, Clostridium, Comomonas, Corynebacterium, Cyanobacteria, Enterobacter, Flavobacteria, Methylosinus, Morganella, Mycobacterium, Pseudomonas, Rhodobacter, Rhodococcus and Streptomyces. Such microbes may also include mycorrhizal fungi that enter into a mutualistic relationship with plant roots and may also have enzymes that may degrade organic contaminants.

Monitoring the system. Root growth can be monitored by measuring the soil moisture content as an indication of the presence or absence of roots with the following method. After the trees are planted, several holes, which are parallel to and a selected distance from the hole containing the subsurface irrigation line, are created using either a Geoprobe or AMS PowerProbe. Soil moisture probes are installed at selected depths in the hole, as the hole is backfilled. Corresponding backfilled holes containing soil moisture probes are also installed next to unplanted holes containing subsurface irrigation lines (control group). Soil moisture is compared between the control group and the planted group at the different depths. For any given depth, if the soil moisture content drops in the planted group and remains the same in the unplanted control group, roots are assumed to be present (i.e. in the zone of soil in which roots proliferate, water use by the trees will dry out the soil).

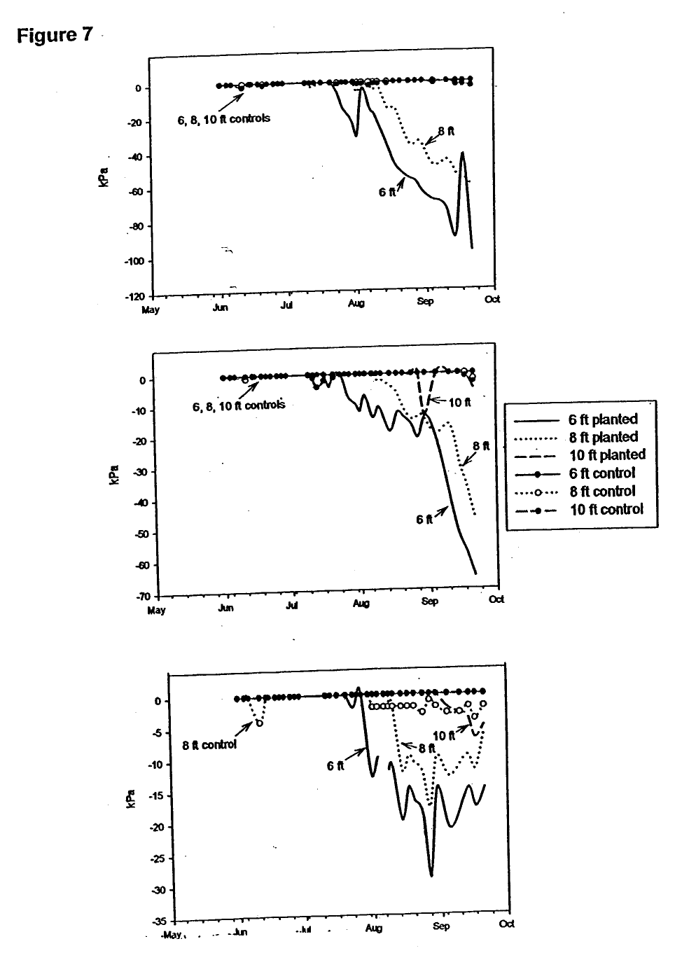

At a site in Billings, Mont., soil moisture probes were installed at 6, 8, and 10 ft below ground surface in backfilled boreholes in which poplars were planted as 8-ft long poles. A subsurface drip irrigation system, with emitters at 1 ft intervals from 5 ft to 12 ft below ground surface, was also installed for each of the boreholes. In addition, a control system was established next to the monitored trees, which comprised of soil moisture probes installed in backfilled boreholes with subsurface irrigation lines but no trees. FIG. 7 shows the results of the soil moisture monitoring over the first growing season. For the control (unplanted) group, soil moisture remained near saturation at all depths. As the season progressed the moisture probes in the planted boreholes decreased sequentially, first at 6 ft bgs, then 8 ft bgs, and finally at the end of the season at 10 ft bgs suggesting that the roots were growing progressively deeper in the backfilled borehole.

Applications. The following examples illustrate how the invention could be used at representative sites.

### EXAMPLE 1

Phytoremediation of Contaminated Soils Deep in the Vadose Zone

The invention could be used at sites containing contaminated soils with the objective of establishing and growing deep-rooted trees at the site and potentially enhancing biodegradation of soil contaminants, especially in the deep vadose zone. For example, at a Superfund Site in Muskegon, Mich., a sludge layer (6 to 11 ft thick extending over a 0.42-acre area) contains intermediate levels of halogenated semi-volatile organic contaminants. The primary remediation objective at the site is to prevent precipitation water from percolating through the sludge layer and leaching contaminants into the groundwater, located 30 ft below ground surface. A secondary objective is to stimulate biodegradation of the contaminants in the sludge. A pilot-scale phytoremediation project was started at the site in 1999, and the preliminary results indicate that at least the surficial layers of sludge are not phytotoxic. However, the trees planted directly in the sludge are assumed to have shallow root systems because they are watered from the surface. Deep-rooted trees would provide a more robust system than shallow-rooted trees because the deep-rooted trees would be able to take up water from the deeper layers of the sludge. Thus, the trees would be more effective at preventing contaminant leaching because the sludge layer could be more thoroughly dried out during the summer and be able to absorb more water during the following winter (i.e. act as a sponge). A deep and extensive root system may also help stimulate biodegradation of contaminants via phytoremediation processes. At this site, a vertical subsurface irrigation line could be installed as described above. Containerized native trees could be planted next to the irrigation line using conventional methods. Irrigation rates could be regulated to produce very deep roots. Moreover, a mixture of nutrients, surfactants, rooting stimulant, and microbes could be added to the irrigation water to accelerate root growth and also stimulate biodegradation of contaminants in the column of soil through which the roots initially develop.

### EXAMPLE 2

Phytoremediation of Deep Groundwater

The invention can be used to produce deep-rooted trees at sites where groundwater phytoremediation is desired, but the groundwater is very deep. For example, at a site in Reno, Nev., a groundwater plume containing chlorinated solvents is migrating towards a fresh water stream. Phytoremediation has been proposed as a cost-effective way of hydraulically controlling the plume. The groundwater at the site is up to 20 ft below ground surface. Thus, for trees to use the groundwater as their primary water source, their roots would have to extend very deeply in the soil profile. Presumably, at such an arid site, roots could be easily lured to the groundwater using subirrigation because rainfall is sparse. A number of subsurface irrigation lines extending to the saturated zone could be installed inexpensively using an AMS PowerProbe or Geoprobe, and 8-ft willow or poplar poles could be planted as poles (7 ft deep) in the same holes with the subirrigation lines. The top 6 ft of the irrigation line would be blank, and emitters would extend from 7 ft below ground surface to 18 ft below ground surface. Irrigation would be regulated to lure the roots down to the saturated zone. Nutrients would also be added via the irrigation lines, and root growth would be monitored using soil moisture probes to quantify where water is being taken up. Soil moisture probes would be installed in adjacent holes at 3-ft intervals, for example, starting at 8 ft below ground surface and extending to 18 ft below ground surface for a subsample of trees. A control, comprising of soil moisture probes installed adjacent to unplanted holes with irrigation lines would also be included. Subirrigation of the trees would be discontinued once the roots tapped into the saturated zone.

### EXAMPLE 3

Phytoremediation of Deep Groundwater at Sites with Contaminated Vadose Zone Soils

The invention could be used at sites where groundwater phytoremediation is needed but the vadose zone soil above the saturation zone is contaminated and possibly phytotoxic. At a site in Casper, Wyo., petroleum hydrocarbons have been released into the subsurface. Historically, the elevation of the water table has fluctuated in response to the water stage of the nearby river. These fluctuations have produced a smear zone, containing residual hydrocarbons, that extends from approximately 5 ft above the water table to 10 ft below the water table (the water table is 15 ft bgs). A phytoremediation system has been proposed to hydraulically control the groundwater and also to help clean up the unsaturated smear zone soils. However, a recent greenhouse experiment showed that the smear zone soil was phytotoxic to two species of willows. For both species, inhibition of root growth in the contaminated soil was 79% relative to control plants grown in clean soil. At this site, the invention could be used to create a clean, nutriated column of soil through which roots could grow. Subsurface irrigation lines would be installed using an AMS PowerProbe or a Geoprobe. Trees would be planted as 8-ft poles (planted 7 ft deep) in the same holes with the subsurface irrigation line. The top 6 ft of the subsurface irrigation line would be blank, and the emitters would be positioned every 1 ft from 7 ft below ground surface to 14 ft below ground surface. Trees would be irrigated with oxygenated water (via the subsurface irrigation lines) to encourage maximum rooting depth. Solutions of nutrients, surfactants, and possibly petroleum-degrading microbes, would be added via a fertilizer proportioner at regular intervals to enhance biodegradation and wash contaminants away from the smear zone near the irrigation line. This would allow the roots to grow down to the groundwater without experiencing phytotoxic effects. Soil moisture probes would be used to track root growth. Subirrigation will be discontinued once the tree roots tap into the water table.

The subject matter claimed is:

1. A method for producing deep-rooted trees for phytoremediation applications comprising:
(a) creating by a direct push technique a small-diameter first hole in soil that extends to a selected depth;
(b) installing one or more vertical subsurface drip lines of a selected size in the first hole;
(c) planting a tree in the first hole, or creating a second hole adjacent to or above the one or more vertical subsurface drip lines and planting the tree in the second hole, and providing water to the tree through the one or more vertical subsurface drip lines.

2. The method of claim 1 wherein the hole has a top and a bottom and the hole is backfilled from the bottom to the top.

3. The method of claim 2 wherein the hole is backfilled with a material comprising a hydrophilic gel.

4. The method of claim 2 wherein the hold is backfilled with a material comprising (a) a mixture of sand and compost or (b) a mixture of sand and peat.

5. The method of claim 1 wherein the subsurface drip lines contain evenly spaced drip emitters.

6. The method of claim 1 wherein the subsurface drip line comprises a top portion and a selected length of the top portion contains no emitters.

7. The method of claim 1 wherein the tree is deeply planted as an unrooted cutting in the first hole or the second hole.

8. The method of claim 7 wherein the tree is a species of Populus or Salix.

9. The method of claim 1 wherein water is emitted through the subsurface drip lines and a rate of irrigation is regulated to promote deep root growth.

10. The method of claim 1 wherein an aqueous solution is emitted through the subsurface drip lines to encourage root growth and nutrient uptake.

11. The method of claim 10 wherein the solution comprises plant nutrients.

12. The method of claim 10 wherein the solution comprises a rooting stimulant.

13. The method of claim 10 wherein the solution comprises a high concentration of dissolved oxygen.

14. The method of claim 13 wherein the one or more vertical subsurface drip lines comprise an inline aerator or oxygenator for increasing dissolved oxygen in water distributed through such lines.

15. The method of claim 10 wherein the solution comprises a suspension of microorganisms.

16. The method of claim 10 wherein the solution emitted through the subsurface drip lines stimulates biodegradation of contaminants and thereby creates a clean column of soil.

17. The method of claim 10 wherein the solution comprises a surfactant.

18. The method of claim 1 further comprising injecting an aqueous solution into the one or more vertical subsurface drip lines using a fertilizer proportioner.

19. A method for producing deep-rooted trees for phytoremediation applications comprising:
(a) creating by a direct push technique a small-diameter hole in soil that extends to a selected depth;
(b) installing one or more vertical subsurface drip lines of a selected size in the hole;
(c) creating a backfilled borehole adjacent to the hole containing the one or more vertical subsurface drip lines; and
(d) planting a tree in the backfilled borehole and providing water through the one or more vertical subsurface drip lines.

20. The method of claim 19 wherein the backfilled borehole is created directly above the hole containing the one or more vertical subsurface drip lines and the borehole is drilled before the one or more vertical subsurface drip lines are installed.
